(19) United States
(12) Patent Application Publication
(10) Pub. No.: US 2014/0062645 A1
(43) Pub. Date: Mar. 6, 2014

(54) TRANSFORMER STRUCTURE

(71) Applicants: Hui-San CHEN, Taipei City (TW); Chih-Tsai Wang, Taipei City (TW); Chih-Ping Kung, Taipei City (TW)

(72) Inventors: Hui-San CHEN, Taipei City (TW); Chih-Tsai Wang, Taipei City (TW); Chih-Ping Kung, Taipei City (TW)

(21) Appl. No.: 13/828,101

(22) Filed: Mar. 14, 2013

(30) Foreign Application Priority Data
Aug. 31, 2012 (TW) 101216903

(51) Int. Cl. H01F 3/04

(52) U.S. Cl. CPC H01F 3/04
USPC 336/212

(57) ABSTRACT

A transformer structure, configured with an assembly of overlapped plural of laminations, a roller and a coil, to provide a transformer with better function of permeability, less weight, lower cost, higher coupling efficiency of electrical energy, and a rapid winding process which could be applied in a variety types of transformer structure or similar products.

### BACKGROUND OF THE INVENTION

1. Field of the Invention

The present invention relates to a transformer structure which includes an iron core configured with plural overlapped laminations, a roller and a coil. The said plural overlapped laminations of the iron core are formed as a quadrilateral lamination with a center plate configured across a pair of two opposite sides as a whole piece. And, the width of center plates varies gradually, increasing from one side to the middle and decreasing from the middle to the other side, to form as an approximate solid cylinder inside the iron core. The said roller is essentially consisting of two half winding parts to form as a rotatable roller structure with a hollow space, and both cover the said approximate solid cylinder. Both sides of each half winding part are further formed as a side frame, and gears are configured at least one side around its outer rim. The coil is then winding around the roller inside the iron core.

2. Description of Related Art

Please refer to the FIGS. 1 to 4. The transformer of prior art is basically comprising plural laminations of iron core (each layer contains an E-shape lamination 50 and an I-shape lamination 60), a winding frame 70 and a coil 80. The coil 80 is initially wound around the winding frame 70. And, each E-shape lamination 50 and an I-shape lamination 60 are alternatively inserted and overlapped from each side of winding frame 70 with wound coil 80. Then, it forms a traditional transformer and provides function of voltage conversion.

As each layer of the traditional transformer contains an E-shape lamination 50 and an I-shape lamination 60, there exists a gap between E-shape lamination 50 and an I-shape lamination 60 joint connection. Consequently, this prior structure causes a defect in electrical energy coupling without matching and it leads to a lower coupling efficiency and energy loss. Also, each layer of E-shape lamination 50 and I-shape lamination 60 forms a shape of square which generates a sharp right angle at the corner of iron core. The said structure lacks symmetrical coupling and lessens permeable function. Furthermore, the prior structure of transformer tends to have a heavy weight from extra volume of unnecessary iron core.

In view of the above discussed problems, the present invention aims to provide a transformer structure with more symmetrical iron core configuration, better electrical energy coupling efficiency, quick manufacturing process and less weight. Therefore, the prior transformer needs to be improved.

### SUMMARY OF THE INVENTION

The primary object of the present invention is to provide a transformer structure, which includes an iron core configured with plural overlapped quadrilateral laminations, a roller and a coil. The said plural overlapped laminations of the iron core are formed as a quadrilateral lamination in one piece with a center plate configured across two opposite sides. Thus, the present invention prevents traditional E-I laminations' joint structure, which results to electro-magnetic mismatching and lower electrical energy coupling efficiency, and provides a better solid configuration for electrical energy conversion.

Another object of the present invention is to provide a transformer structure, which includes an iron core configured with plural overlapped quadrilateral laminations, a roller and a coil, wherein the center plates are sequentially configured across a pair of opposite sides and the width of center plates varies gradually, increasing from one side to the middle and decreasing from the middle to the other side, to form as an approximate solid cylinder inside the iron core structure. The said roller is essentially consisting of two half winding parts to form as a rotatable roller structure with a hollow space, and both cover the said approximate solid cylinder.

And, one more object of the present invention is to provide a transformer structure, which includes an iron core configured with plural overlapped quadrilateral laminations, a roller and a coil, wherein the four corners of each quadrilateral lamination are formed as an arc configuration to enhance coupling efficiency. Besides, the four external sides of the iron core are configured as an arc surface by varying the area of each quadrilateral lamination from one side to the middle and decreasing from the middle to the other side. Thus, the present invention can reduce the weight and have a more symmetrical structure.

Furthermore, the present invention is to provide a transformer structure, which includes an iron core configured with plural overlapped quadrilateral laminations, a roller and a coil, wherein the roller is actually consisting of both half winding parts to form a hollow space for accommodating the above-said approximate solid cylinder inside the iron core structure. Both side frames of the roller are at least one side configured with gears around its outer circumference. The coil is then winding around the roller inside the space of the iron core.

By above-mentioned configuration, the present invention is applicable to provide a transformer structure with a lot of improvements, for example, more symmetrical iron core configuration, better electrical energy coupling efficiency, quick manufacturing process and less weight, etc.

The function and structure of practical embodiments can be further understood via the drawings listed below.

### BRIEF DESCRIPTION OF THE DRAWINGS

The present invention can be fully understood from the following detailed description and preferred embodiment with reference to the accompanying drawings, in which:

FIG. 1 is a three-dimensional appearance of the prior art;

FIG. 2 is a three-dimensional element decomposition view of the prior art;

FIG. 3 is schematic cross-section view of the prior art;

FIG. 4 is an another schematic cross-section view of the prior art;

FIG. 5 shows a three-dimensional appearance of the present invention;

FIG. 6 shows a three-dimensional element decomposition view of the present invention;

FIG. 7 shows a schematic cross-section view of the present invention;

FIG. 8 shows an another schematic cross-section view of the present invention;

FIG. 9 shows a schematic winding view of the present invention; and

FIG. 10 shows a schematic winding action of the present invention.

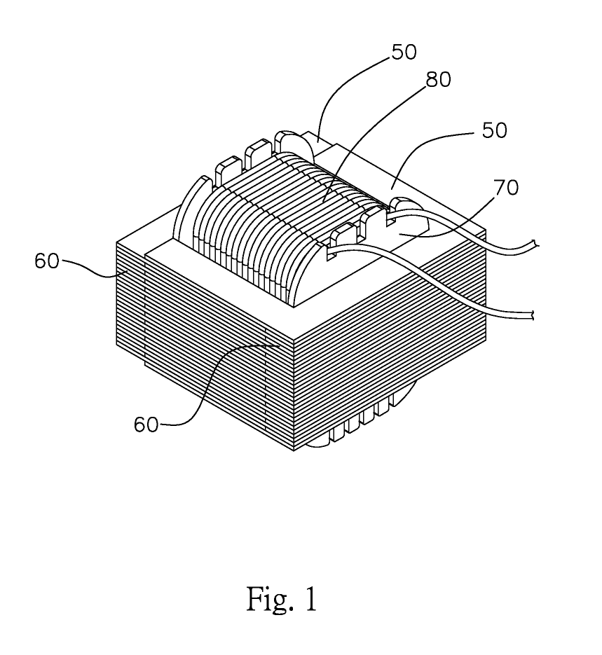

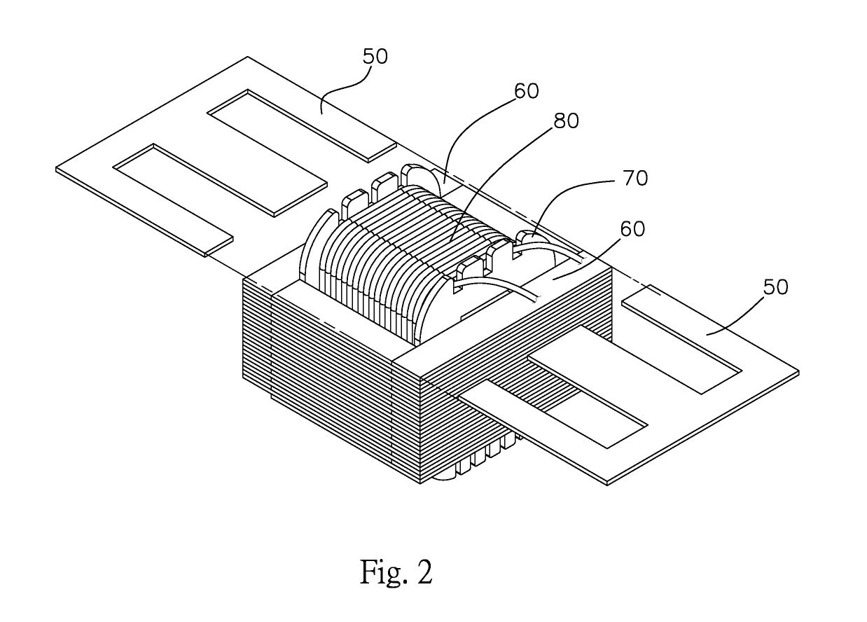

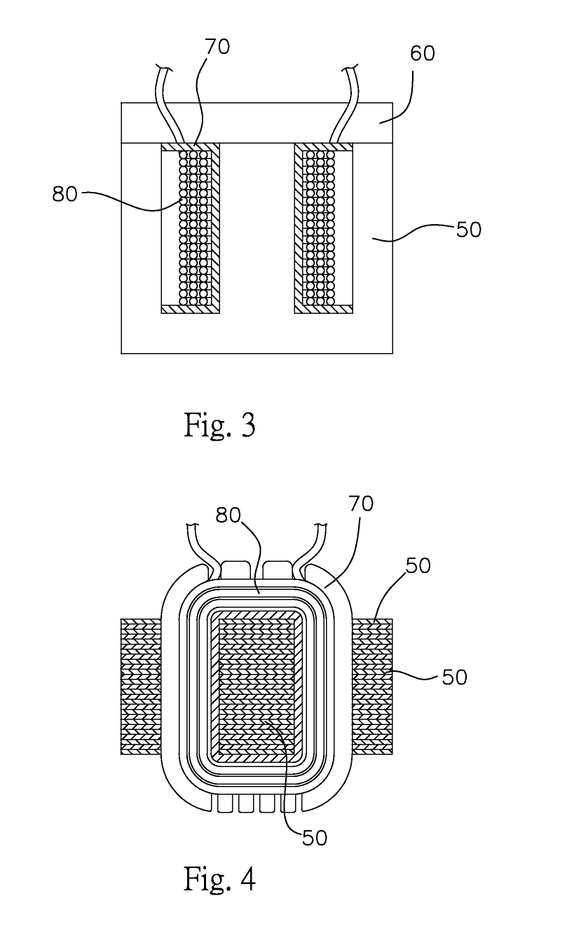

### DETAILED DESCRIPTION OF THE PREFERRED EMBODIMENTS

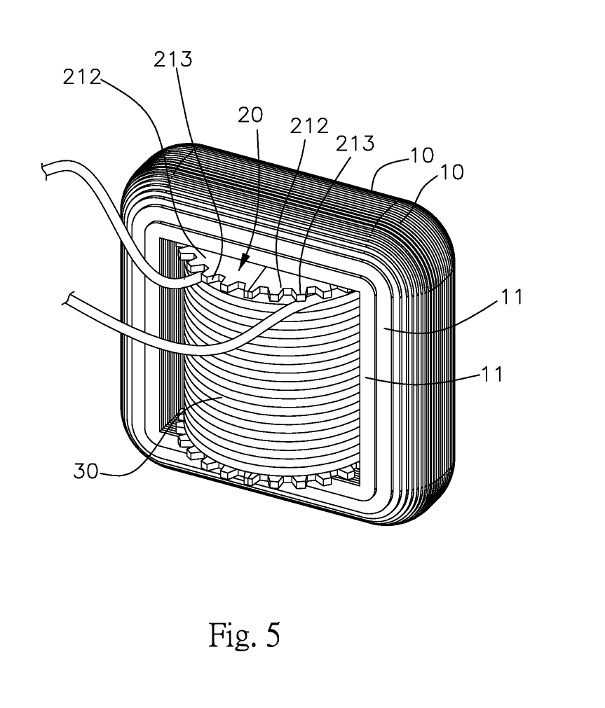

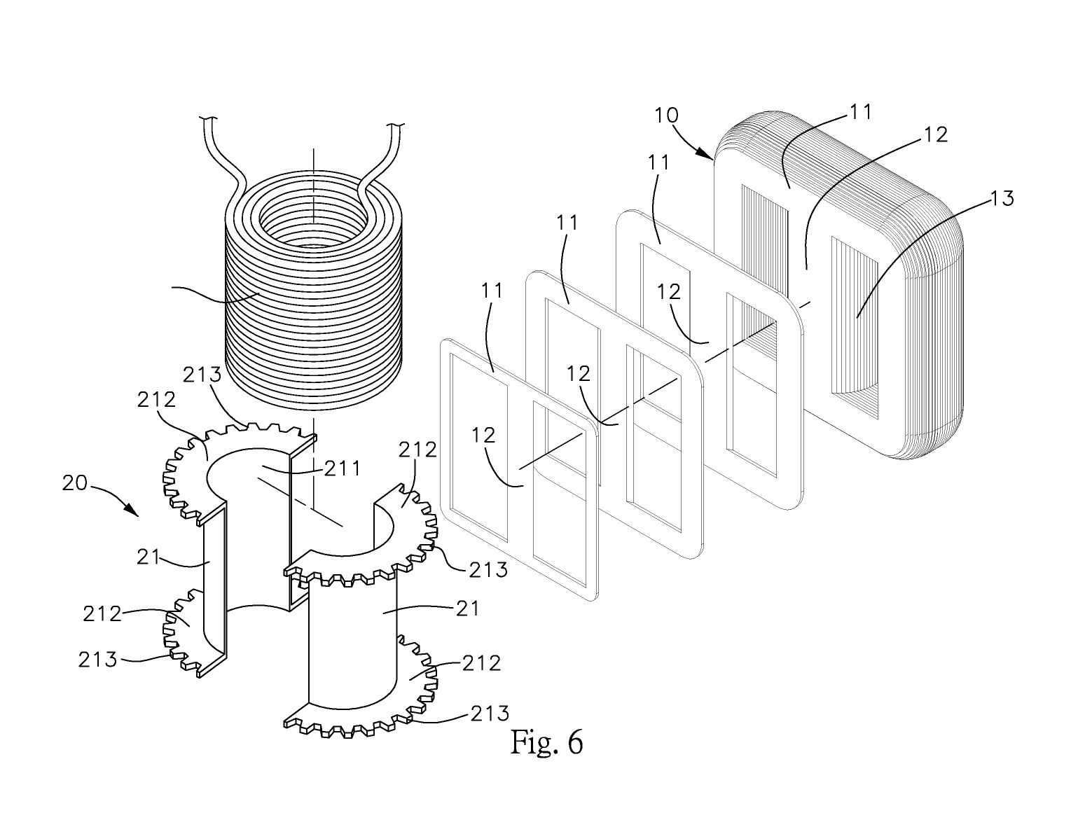

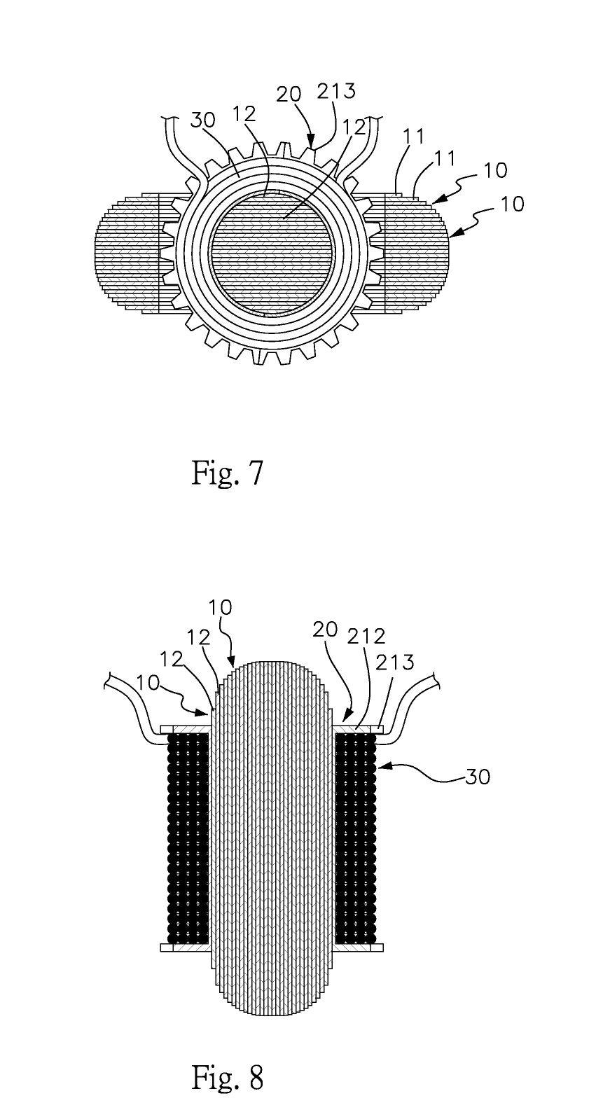

Referring to FIGS. 5˜8, the present invention relates to a transformer structure and comprises an iron core 10, a roller 20 and a coil 30.

The iron core 10, which is configured with plural overlapped quadrilateral laminations 11 and each layer is formed as a whole piece with a center plate 12 configured across a pair of two opposite sides. And, the width of center plates 12 varies gradually, increasing from one side to the middle and decreasing from the middle to the other side, to form as an approximate cylindrical post 13 inside the iron core 10.

The four corners of each quadrilateral lamination 11 are formed as an arc configuration to enhance coupling efficiency. Besides, the four external sides and corners of the iron core 10 are configured as an arc surface by varying the area of each quadrilateral lamination 11 from one side to the middle and decreasing from the middle to the other side. Therefore, the present invention provides a lighter weight, material-saving and has a more symmetrical structure.

The roller 20 is essentially consisting of two half winding parts 21 to form as a rotatable roller 20 structure with a hollow space 211, and to cover and accommodate the said approximate cylindrical post 13. Both side frames 212 of the roller 20 are at least one side configured with gears 213 around its outer circumference. The coil 30 is then winding around the roller 20 inside the space of iron core 10.

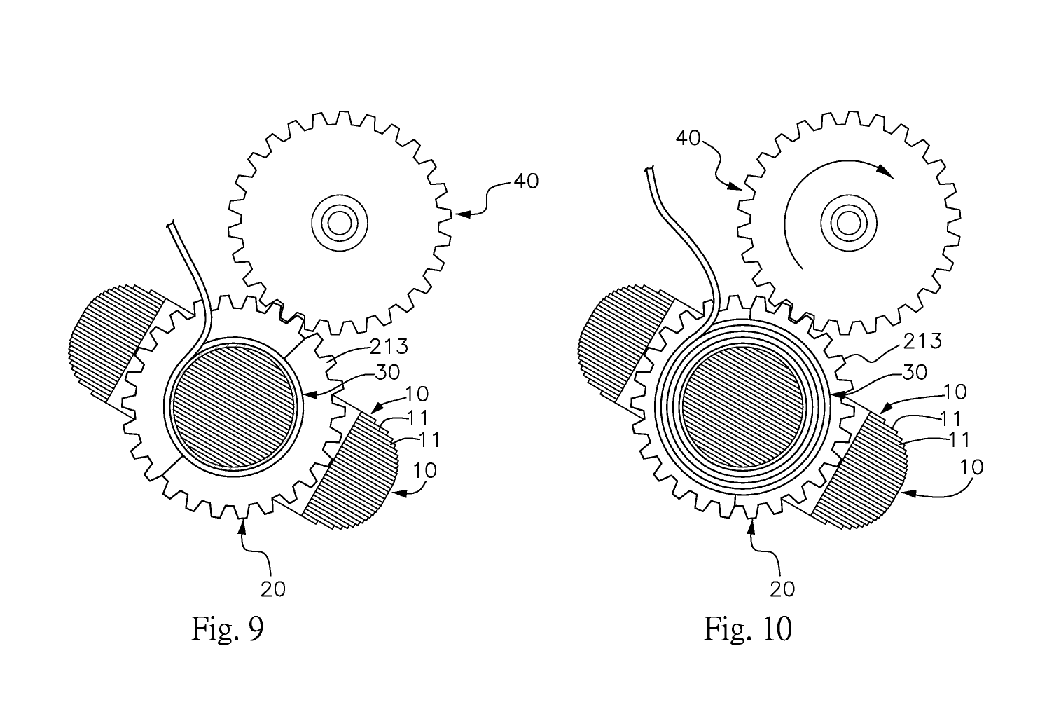

Further referring to FIGS. 9˜10, when it comes to the coil winding process, an external rolling gear 40 is at least one side engaged with the gears 213 configured around the outer circumference of side frames 212. As the roller 20 is rotatable around the cylindrical post 13, the present invention provides a quick and stable coil winding process which improves many characteristics of a prior transformer structure, such as electrical power coupling efficiency, less leakage of electro-magnetic waves, higher permeability, lighter weight and lower cost, and so on.

Of course, it is to be understood that the embodiments described herein are merely some illustrations related to the objects of the invention and that a wide variety of modifications thereto may be adopted without departing from the purpose and the scope of the present invention as set forth in the following claims.

What is claimed is:

1. A transformer structure, comprises
an iron core, which is configured with plural overlapped quadrilateral laminations and each layer of quadrilateral laminations is formed as a whole piece with a center plate configured across a pair of two opposite sides, and the width of center plates varies gradually, increasing from one side to the middle and decreasing from the middle to the other side, to form as a cylindrical post inside the iron core;
a roller, which is essentially consisting of two half winding parts to form as a rotatable roller structure with a hollow space, and to cover and accommodate the said cylindrical post, and both side frames of the roller are at least one side configured with gears around its outer circumference; and
a coil, which is wound around the roller inside the space of iron core.

2. A transformer structure according to claim 1, wherein the four corners of each quadrilateral lamination are formed as an arc configuration.

3. A transformer structure according to claim 1, wherein the four external sides and corners of the iron core are configured as an arc surface by increasing the area of each quadrilateral lamination from one side to the middle and decreasing from the middle to the other side.
